(19) United States
(12) Patent Application Publication
(10) Pub. No.: US 2022/0262046 A1
(43) Pub. Date: Aug. 18, 2022

(54) INFORMATION DISPLAYING METHOD AND COMPUTER-READABLE RECORDING MEDIUM IN WHICH PROGRAM FOR EXECUTING INFORMATION DISPLAYING METHOD IS STORED

(71) Applicants: HYUNDAI MOTOR COMPANY, Seoul (KR); Kia Corporation, Seoul (KR)

(72) Inventors: Rowoon AN, Seoul (KR); Jae Yul WOO, Seoul (KR); Seunghyun WOO, Seoul (KR); Soobin KIM, Seoul (KR)

(73) Assignees: HYUNDAI MOTOR COMPANY, Seoul (KR); Kia Corporation, Seoul (KR)

(21) Appl. No.: 17/531,277

(22) Filed: Nov. 19, 2021

(30) Foreign Application Priority Data
Feb. 17, 2021 (KR) 10-2021-0021031

(51) Int. Cl. G06T 11/00; G06T 3/40

(52) U.S. Cl. CPC G06T 11/001; G06T 3/40

(57) ABSTRACT

The image displaying method, capable of intuitively displaying various pieces of information about a point of interest (POI) to a user in the form of an icon, includes: controlling a camera of a user terminal to acquire a surrounding area of the user terminal; controlling a communication module of the user terminal to receive location information of a point of interest (POI) from a server; controlling a display of the user terminal to display a composite image by synthesizing an icon, in which the location information of the POI is displayed, in a partial area of the surrounding image; and changing a size of the icon based on a distance between the user terminal and the POI.

### CROSS-REFERENCE TO RELATED APPLICATION

This application is based on and claims priority under 35 U.S.C. § 119 to Korean Patent Application No. 10-2021-0021031, filed on Feb. 17, 2021 in the Korean Intellectual Property Office, the disclosure of which is incorporated herein by reference.

### TECHNICAL FIELD

The disclosure relates to an information displaying method and a computer-readable recording medium in which a program for executing the information displaying method is stored, and more specifically, to an information displaying method capable of displaying virtual image information, in which various pieces of information about a point of interest (POI) are displayed, in a partial area of a real image photographed through a user terminal, and a computer-readable recording medium in which a program for executing the information displaying method is stored.

### BACKGROUND

A location based service (LBS) is a service that provides a user of a wireless Internet or a user terminal (e.g., a smart phone) with specific information according to the location of the user. The LBS may generate a variety of information by providing local information specialized to the user, and the potential applicability is considered limitless. Some examples of the LBS provide useful information in practice, such as checking local information of nearby locations or facilities (e.g., a gas station or restaurant), finding the location of a counter party, and the like.

In particular, user terminals, widely used nowadays, are equipped with a camera to capture an image, and display the image through a screen, and thus enables a method of projecting various pieces of information onto the screen of the terminal by combining local information provided through the LBS with the image captured by the camera, so that an augmented reality (AR) service may be implemented. AR is a complex virtual reality that fuses a real environment with a virtual environment using a technology that shows a virtual object overlaid on a camera image that the user sees in practice. By combining the virtual world with the real world, the AR may provide users with the benefits of LBSs maximally.

### SUMMARY

The present disclosure provides an information displaying method capable of intuitively displaying various pieces of information about a point of interest (POI) to a user in the form of an icon, while simultaneously displaying an image in the direction in which the user is moving, thereby preventing the user's gaze from being restricted during movement, and a computer-readable recording medium in which a program for executing the information displaying method is stored.

Additional aspects of the disclosure will be set forth in part in the description which follows and, in part, will be obvious from the description, or may be learned by practice of the disclosure.

According to an aspect of the disclosure, there is provided an image displaying method including: controlling a camera of a user terminal to acquire an image of a surrounding area of the user terminal; controlling a communication module of the user terminal to receive location information of a point of interest (POI) from a server; controlling a display of the user terminal to display a composite image by synthesizing an icon, in which the location information of the POI is displayed, in a partial area of the surrounding image; and changing a size of the icon based on a distance between the user terminal and the POI.

The changing of the size of the icon may include increasing the size of the icon as the distance between the user terminal and the POI decreases.

The image displaying method may further include: controlling the communication module to receive information about whether the POI is open or closed from the server; and controlling the display to display the information about whether the POI is open or closed on the icon.

The controlling of the display to display the information about whether the POI is open or closed on the icon may include displaying on the icon different colors respectively indicating whether the POI is open or closed.

The image displaying method may further include: controlling the display to display a logo of the POI on the icon.

The controlling of the display to display the logo of the POI on the icon may include, if the distance between the user terminal and the POI is less than a preset value, controlling the display to display the logo of the POI on the icon.

The POI may include a parking lot. The image displaying method may further include: controlling the display to display at least one of user evaluation information for the parking lot, parking fee information for the parking lot, or parking available space information for the parking lot on the icon.

The controlling of the display to display the parking available space information may include controlling the display to display different colors on the icon respectively indicating whether a ratio of a parking available space to a total parking space of the parking lot being greater than or equal to, or less than a reference ratio.

The POI may include a store. The image displaying method may further include controlling the display to display at least one of user evaluation information for the store, price information of a service for the store, or congestion level information for the store on the icon.

The image displaying method may further include: controlling the communication module to receive information about a plurality of POIs from the server; determining a recommended POI based on at least one of user evaluation information, price information of a service, or congestion level information for each of the plurality of POIs; and generating an icon in which location information of the recommended POI is displayed.

According to an aspect of the disclosure, there is provided a non-transitory computer-readable recording medium storing a program an information displaying method, the program executable by a processor to cause the processor to perform operation including: controlling a camera of a user terminal to acquire an image of a surrounding area of the user terminal; controlling a communication module of the user terminal to receive location information of a point of interest (POI) from a server controlling a display of the user terminal to display a composite image by synthesizing an icon, in which the location information of the POI is displayed, in a partial area of the surrounding image; and changing a size of the icon based on a distance between the user terminal and the POI.

The changing of the size of the icon may include increasing the size of the icon as the distance between the user terminal and the POI decreases.

The operations may further include: controlling the communication module to receive information about whether the POI is open or closed from the server; and controlling the display to display the information about whether the POI is open or closed on the icon.

The controlling of the display to display the information about whether the POI is open or closed on the icon may include displaying on the icon different colors respectively indicating whether the POI is open or closed.

The operations may further include controlling the display to display a logo of the POI on the icon.

The controlling of the display to display the logo of the POI on the icon may include, if the distance between the user terminal and the POI is less than a preset value, controlling the display to display the logo of the POI on the icon.

The POI may include a parking lot. The operations may further include controlling the display to display at least one of user evaluation information for the parking lot, parking fee information for the parking lot, or parking available space information for the parking lot on the icon.

The controlling of the display to display the parking available space information may include controlling the display to display different colors on the icon respectively indicating whether a ratio of a parking available space to a total parking space of the parking lot being greater than or equal to, or less than a reference ratio.

The POI may include a store. The operations may further include controlling the display to display at least one of user evaluation information for the store, price information of a service for the store, or congestion level information for the store on the icon.

The operations may further include: controlling the communication module to receive information about a plurality of POIs from the server; determining a recommended POI based on at least one of user evaluation information, price information of a service, or congestion level information for each of the plurality of POIs; and generating an icon in which location information of the recommended POI is displayed.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating an information displaying method according to an embodiment;

FIG. 2 is a diagram illustrating an information displaying method according to another embodiment;

FIG. 3 is a control block diagram illustrating a user terminal according to an embodiment;

FIG. 4 is a diagram for describing a change in the size of an icon according to an embodiment;

FIG. 5 is a diagram for describing that a logo of a point of interest (POI) is displayed on an icon according to an embodiment;

FIG. 6 is a diagram for describing a case in which a gas station is a POI according to an embodiment;

FIG. 7 is a diagram for describing a case in which a hospital is a POI according to an embodiment; and

FIG. 8 is a flowchart showing an information displaying method according to an embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Further, when it is stated that a member is “on” another member, the member may be directly on the other member or a third member may be disposed therebetween.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the disclosure will be described with reference to the accompanying drawings.

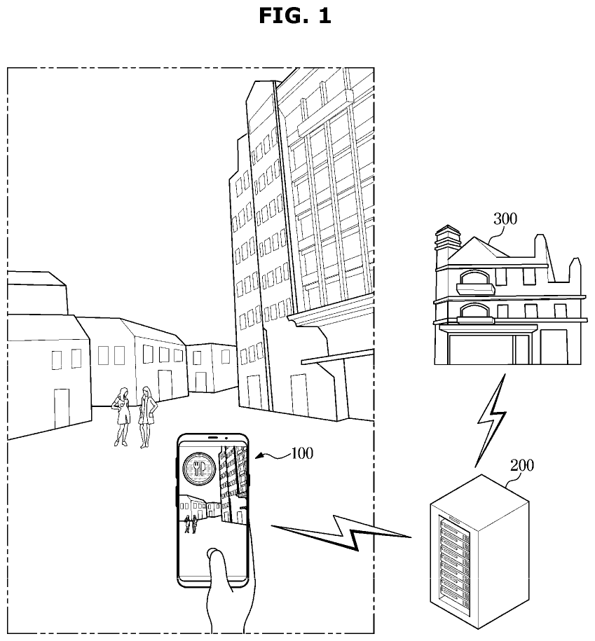

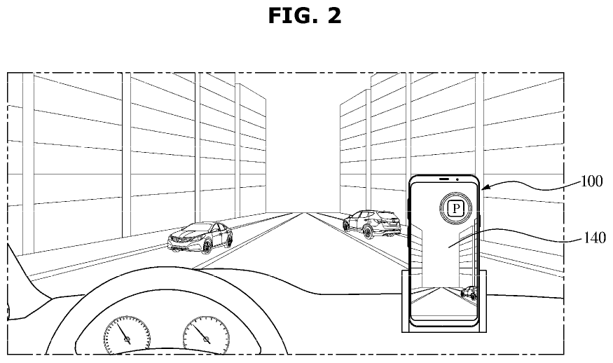

FIG. 1 is a diagram illustrating an information displaying method according to an embodiment, and FIG. 2 is a diagram illustrating an information displaying method according to another embodiment.

Referring to FIG. 1, a user may acquire location information of a point of interest (POI) 300 through a user terminal 100.

A server 200 may transmit the location information of the POI 300 to the user terminal 100.

The POI 300 may be a destination in which the user is interested. For example, if a user desires to visit a cafe of a specific brand, a cafe store of the corresponding brand may be the POI 300.

The user may visit the POI 300 while checking the location information of the POI 300 through the user terminal 100.

A terminal of the POI 300 may transmit information about whether the POI 300 is open or closed, parking space information of the POI 300, parking fee information of the POI 300, price information of a service of the POI 300, congestion level information of the POI 300, and the like, to the server 200.

In addition, the server 200 may store information about whether the POI 300 is open, logo information of the POI 300, parking information of the POI 300, the price information of a service of the POI 300, user evaluation information of the POI 300, and the like in advance.

The server 200 may transmit information about whether the POI 300 is open, logo information of the POI 300, the parking fee information of the POI 300, parking available space and/or fee information of the POI 300, the price information of the service of the POI 300, congestion level information of the POI 300, the user evaluation information of the POI 300, etc. to the user terminal 100.

The user may visit the POI 300 while checking various pieces of information about the POI 300 through the user terminal 100.

As described above, the amount of information about the POI 300 that may be provided to the user is vast, but in order to visit the POI 300, the user needs to move so there may be restrictions on the hand movements or gaze. That is, it may be desirable to display information about the POI 300 to the user, while displaying an image in the direction in which the user is moving.

On a screen displayed through a display 140 of the user terminal 100, not only location information of the POI 300 and various pieces of information about the POI 300 but also an image captured by the camera 110 of the user terminal 100 are displayed.

That is, the display 140 of the user terminal 100 may display information in a method of augmented reality (AR) displaying virtual image information, in which location information of the POI 300 and various pieces of information about the POI 300 are displayed, in a partial area of a real image being captured by the camera 110 in real time.

Referring to FIG. 2, the user may acquire location information of the POI 300 and various pieces of information about the POI 300 through the user terminal 100 while the user terminal 100 is mounted on the vehicle to capture an image of the front of the vehicle.

That is, the user may acquire information about the POI 300 through the user terminal 100 while travelling using a vehicle, as well as while walking.

When the user is a driver, the POI 300 may be a destination in which the driver is interested. For example, if the user desires to visit a specific parking lot or gas station, the corresponding parking lot or gas station branch may be the POI 300.

The display 140 of the user terminal 100 may simultaneously display the location information of the POI 300 and the various pieces of information about the POI 300 as well as the image being captured by the camera 110 of the user terminal 100. Therefore, even if the driver checks the information about the POI 300 while looking at the display 140 on driving, since the driver may simultaneously check the situation in front of the vehicle, safe travelling may be ensured.

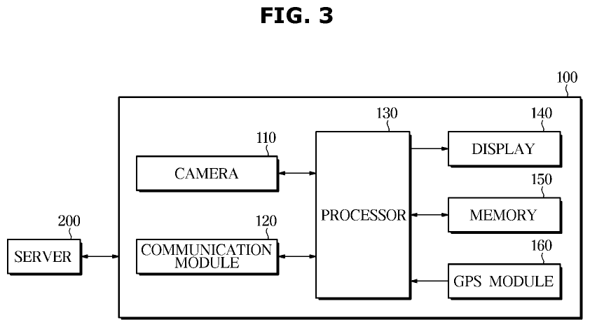

FIG. 3 is a control block diagram illustrating a user terminal according to an embodiment.

Referring to FIG. 3, a user terminal 100 may include a camera 110, a communication module 120, a processor 130, a display 140, a memory 150, and a global positioning system (GPS) module 160.

The camera 110 may acquire a surrounding image of the user terminal 100. In this case, the processor 130 may control the camera 110 to acquire the surrounding image.

The communication module 120 may receive location information of a POI 300 from a server 200. In this case, the processor 130 may control the communication module 120 to receive the location information of the POI 300 from the server 200.

The processor 130 may generate an icon 1400 in which the location information of the POI 300 is displayed.

The location information of the POI may be direction information of the POI 300 and distance information to the POI 300 based on the current location of the user terminal 100.

For example, if the POI 300 is located 0.5 km ahead based on the current location of the user terminal 100 and the direction in which the user terminal 100 faces, a location information icon 1401 in an arrow-shape indicating “0.5 km straight ahead” may be generated.

The processor 130 may generate a composite image by synthesizing the generated icon 1400 in a partial area of the surrounding image. In this case, the position of the icon 1400 may be located in a partial area of the right side of the surrounding image, but is not limited thereto. That is, the icon 1400 may be located in any area of the surrounding image, as long as it does not cause difficulty for user to simultaneously check the information displayed on the icon 1400 and the surrounding image without overly covering the surrounding image.

The display 140 of the user terminal 100 may display the generated composite image. In this case, the processor 130 may control the display 140 to display the composite image.

The processor 130 may change the size of the icon 1400 of the composite image based on the distance between the user terminal 100 and the POI 300.

Specifically, the processor 130 may increase the size of the icon 1400 as the distance between the user terminal 100 and the POI 300 decreases. In addition, the processor 130 may decrease the size of the icon 1400 as the distance between the user terminal 100 and the POI 300 increases.

However, the method in which the size of the icon 1400 is changed is not limited thereto, as long as it can allow the change in distance between the user terminal 100 and the POI 300 to be recognized by the user through the change in size of the icon 1400.

In order for the processor 130 of the user terminal 100 to calculate the distance between the user terminal 100 and the POI 300 and the change in distance, the processor 130 needs to identify positioning information of the user terminal 100.

Accordingly, the processor 130 may use information received by the global positioning system (GPS) module 160.

The GPS module 160 may receive a satellite signal including navigation data from at least one GPS satellite. The processor 130 may acquire the current location of the user terminal 100 and the heading direction of the user terminal 100 based on the satellite signal.

The GPS module 160 may receive GPS information transmitted by a GPS satellite. The GPS module 160 may transmit the GPS information to the processor 130. When the GPS module 160 transmits the GPS information to the processor 130, the processor 130 may compare time information contained in the GPS information transmitted by the GPS satellite with a time at which the GPS receiver receives the GPS information to calculate the distance between the satellite and the GPS receiver, and determine the current location of the GPS module 160 based on the calculated distance. In this case, the processor 130 may represent the current location of the GPS module 160 as position coordinates on the absolute coordinate system. As described above, the processor 130 of the user terminal 100 may generate location information of the user terminal 100 based on the received GPS information.

As described above, the processor 130 may be provided in the user terminal 100 to provide a composite image to the user, but the processor 130 does not need to be provided in the user terminal 100 and may be provided in various positions as long as it can provide a user with a composite image by synthesizing the icon 1400 in a partial area of a surrounding image,

For example, the processor may be provided in the server 200 to generate a composite image based on location information of the user terminal 100 and a surrounding image received from the communication module 120 of the user terminal 100. The following description will be made according to an embodiment in which the processor 130 is provided in the user terminal 100.

The embodiment of the present disclosure described so far and an information displaying method according to an embodiment to be described below may be implemented in the form of a program that may be run by the user terminal 100.

Here, the program may include program instructions, data files, and data structures alone or in combination. The program may be designed and manufactured using machine codes or high-level language codes. The program may be specially designed to implement the above-described code correction method, or may be implemented using various functions or definitions that are known and available to those skilled in the art of computer software. A program for implementing the above-described information displaying method may be recorded in a recording medium readable by the processor 130 of the user terminal 100. In this case, the recording medium may be the memory 150 of the user terminal 100.

The server 200 may store a program for executing the method described above and the method described below. The program stored in the server 200 may be stored in the memory 150 by being downloaded to the user terminal 100. That is, the user may download a program or application from the server 200 for executing by, for example, the processor 130, to perform the method described above and the method described below, and use the program or application through the user terminal 100.

The memory 150 may store a program for performing the above-described operation and the operation to be described below, and the processor 130 may execute the stored program. When the memory 150 and the processor 130 are each provided in plural, the memory 150 and the processor 130 may be implemented as a single chip, or may be implemented as separate chips. The memory 150 may include a volatile memory, such as an S-RAM, a D-RAM, and the like. The memory 150 may include a non-volatile memory for long-term storage of control programs and control data, such as a read only memory (ROM), an erasable programmable read only memory (EPROM), electrically erasable programmable read only memory (EEPROM) and the like. The processor 130 may include various logic circuits and arithmetic circuits, process data according to a program provided from the memory 150, and generate a control signal according to the processing result.

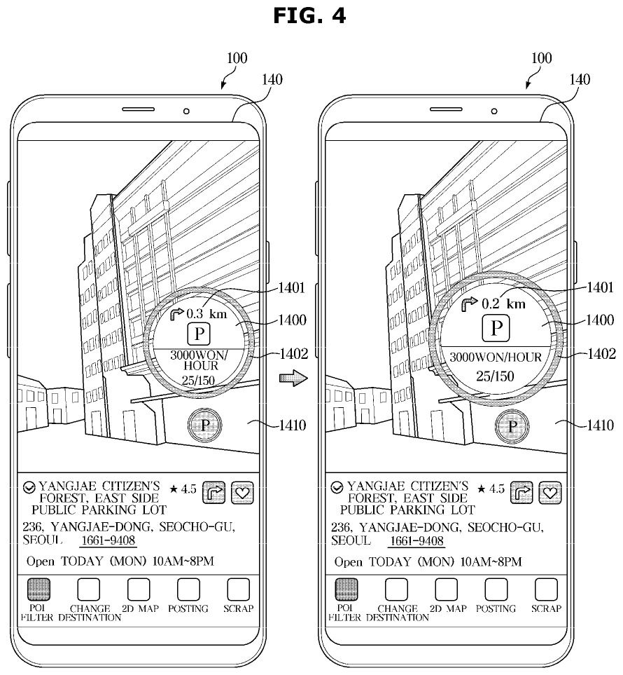

FIG. 4 is a diagram for describing a change in the size of an icon according to an embodiment.

Referring to FIG. 4, the display 140 may display a composite image by synthesizing an icon 1400 in a partial area of a surrounding image 1410.

The icon 1400 may have a shape of a circle as shown in FIG. 4. However, the shape of the icon 1400 is not limited thereto, and may be provided in any shape as long as it can allow the user to recognize the icon 1400, which is a virtual image that is distinguished from surrounding images captured in practice.

A category image may be a pictogram image classified for each type of the POI 300. For example, if the POI 300 is a restaurant, the category image corresponding to the POI may be a fork and knife-shaped pictogram image, and if the POI 300 is a gas station, the category image corresponding to the POI 300 may be a fuel injector-shaped pictogram image. That is, category images corresponding to each type of the POI 300 may exist.

When a user desires to park a vehicle, a specific parking lot may be the POI 300. In this case, an image “P”, which is a category image of a parking lot, may be displayed on the icon 1400 as shown in FIG. 4.

In this case, the processor 130 may control the communication module 120 to receive location information of the specific parking lot from the server 200.

In addition, the processor 130 may generate the icon 1400 in which the location information of the specific parking lot is displayed.

For example, if the POI 300 is located in the right direction from 0.3 km ahead based on the current location of the user terminal 100 and the direction in which the user terminal 100 faces, a location information icon 1401 in an arrow shape indicating “turn right after going straight 0.3 km” may be generated and displayed on the icon 1400 of the composite image.

The processor 130 may change the size of the icon 1400 of the composite image based on the distance between the user terminal 100 and the specific parking lot.

Referring to FIG. 4, it can be seen that as the user terminal 100 approaches the specific parking lot, the size of the icon 1400 in the shape of a circle increases. For example, when the location of the user terminal 100 changes and the distance between the user terminal 100 and the specific parking lot decreases from 0.3 km to 0.2 km, the size of the icon 1400 may increase.

The communication module 120 may receive information about whether the POI 300 is open from the server 200. In this case, the processor 130 may control the communication module 120 to receive the information about whether the POI 300 is open from the server 200.

For example, the processor 130 may control the communication module 120 to receive information about whether a specific parking lot is open from the server 200.

The processor 130 may control the display 140 to display the information about whether the POI 300 is open on the icon 1400.

In this case, if the POI 300 is currently open, the processor 130 may control the display 140 to display the first color on the icon 1400. The first color may be green or blue, but is not limited thereto.

For example, if a specific parking lot is currently open, the processor 130 may display an operation status information icon 1402 having a ring-shape and located on the edge of the icon 1400 in a circular shape, to be in green.

The processor 130, if the POI 300 is not currently open, may control the display 140 to display a color different from the first color on the icon 1400. For example, if a specific parking lot is not currently open, the processor 130 may display the operation status information icon 1402 to be in gray. However, the color indicating that the POI 300 is not currently open is not limited to gray.

In addition, if the processor 130 does not identify whether the POI 300 is currently open, the processor 130 may display the operation status information icon 1402 to be in white. However, the color indicating that it is unknown whether the POI 300 is open is not limited to white.

The processor 130 may control the display 140 to display a logo of the POI 300 on the icon 1400. For example, if the POI 300 is a parking lot and the parking lot has a logo, the logo of the parking lot may be displayed on the icon 1400 instead of a category image “P” of the parking lot.

On the other hand, if the parking lot does not have a logo, as shown in FIG. 4, a mark “P”, which is a category image of the parking lot, may be displayed on the icon 1400 instead of the logo of the parking lot.

When the POI 300 is a parking lot, the processor 130 may control the display 140 to display at least one of user evaluation information for the specific parking lot, parking fee information for the specific parking lot, and parking available space information for the specific parking lot on the icon 1400.

Meanwhile, it is not that the user evaluation information for the parking lot, the parking fee information for the parking lot, and the parking available space information for the parking lot need to be displayed on the icon 1400. For example, as shown in FIG. 4, when the user evaluation of a specific parking lot is 4.5 out of 5, the user evaluation information may not be displayed on the circular icon 1400, but may be displayed with a star-shaped figure and a numerical value “4.5” elsewhere on the screen.

The processor 130 may control the display 140 to display the parking fee per hour on the icon 1400 as shown in FIG. 4.

The processor 130 may control the display 140 to display the parking available space information on the icon 1400 as shown in FIG. 4. For example, when the total parking space of a specific parking lot is 150 and an empty parking available space is 25, the parking available space information indicated as “25/150” may be displayed on the icon 1400.

The processor 130 may control the display 140 to display the second color on the icon 1400 when the ratio of the parking available space to the total parking space of the parking lot is greater than or equal to than a reference ratio. In this case, the second color may be blue, but is not limited thereto.

For example, if the reference ratio is 66% and the ratio of the parking available space to the total parking space of the parking lot is 66% or more, the color of the parking available space information displayed on the icon 1400 may be displayed in blue. That is, in the case of parking available space information displayed in the form of “140/150”, the value of “140” indicating an empty parking available space may be displayed in blue.

Conversely, if the ratio of the parking available space to the total parking space of the parking lot is less than or equal to the reference ratio, the processor 130 may control the display 140 to display a red color on the icon 1400. In this case, the displayed color is not limited to red.

For example, if the reference ratio is 33%, and the ratio of the parking available space to the total parking space of the parking lot is less than 33%, the color of the parking available space information displayed on the icon 1400 may be displayed in red. That is, in the case of parking available space information displayed in the form of “25/150”, the value of “25” indicating an empty parking available space may be displayed in red.

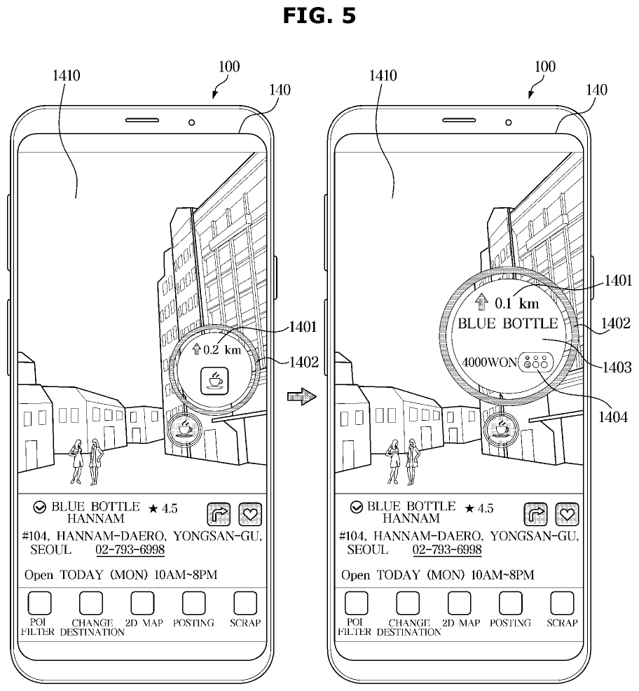

FIG. 5 is a diagram for describing that a logo of a point of interest (POI) is displayed on an icon according to an embodiment.

When a user desires to visit a cafe, a store of a specific cafe brand may be a POI. In this case, a coffee cup shape, which is a category image of a cafe, may be displayed on the icon 1400 as shown in FIG. 5.

In this case, the processor 130 may control the communication module 120 to receive location information of the store of the specific cafe brand from the server 200.

In addition, the processor 130 may generate the icon 1400 in which the location information of the store of the specific cafe brand is displayed.

For example, if the POI 300 is located 0.2 km ahead based on the current location of the user terminal 100 and the direction in which the user terminal 100 faces, a location information icon 1401 in an arrow shape indicating “0.2 km straight ahead” may be generated and displayed on the icon 1400 of the composite image.

The processor 130 may change the size of the icon 1400 of the composite image based on the distance between the user terminal 100 and the store of the specific cafe brand.

Referring to FIG. 5, it can be seen that the size of the icon 1400 in the shape of a circle increases as the user terminal 100 approaches the store of the specific cafe brand. For example, as illustrated in FIG. 5, when the location of the user terminal 100 changes and the distance between the user terminal 100 and the store of the specific cafe brand decreases from 0.2 km to 0.1 km, the size of the icon 1400 may increase.

The processor 130 may control the communication module 120 to receive information about whether the store of the specific cafe brand is open from the server 200. The processor 130 may control the display 140 to display the information about whether the store of the specific cafe brand is open on the icon 1400.

The processor 130 may control the display 140 to display the logo of the POI 300 on the icon 1400. For example, if the store of the specific cafe brand has a logo, the logo of the specific cafe brand may be displayed on the icon 1400.

If the distance between the user terminal 100 and the POI 300 is less than a preset value, the processor 130 may control the display 140 to display the logo of the POI 300 on the icon 1400.

Conversely, if the distance between the user terminal 100 and the POI 300 is greater than or equal to the preset value, the processor 130 may control the display to display the category image of the POI 300 instead of the logo of the POI 300 on the icon 1400.

For example, if the preset value is 0.15 km, and the distance between the user terminal 100 and the store of the specific cafe brand, which is a POI, is 0.2 km, a coffee cup-shaped mark, which is a category image of a specific cafe brand, may be displayed on the icon 1400 instead of the logo of the brand.

In this case, when the user approaches the store of the specific cafe brand while holding the user terminal 100 and the distance between the user terminal 100 and the specific cafe brand store, which is the POI, becomes less than 0.15 km, a logo information icon 1403 of the specific cafe brand may be displayed on the icon 1400 as shown in FIG. 5.

As described above, the POI 300 may include a store. That is, the POI 300 may include any place that sells products or services, such as a cafe, a restaurant, and a convenience store.

When the POI 300 is a store, the processor 130 may control the displays 140 to display at least one of user evaluation information for the specific store, price information of a service for the specific store, or congestion level information for the specific store on the icon 1400.

The congestion level information may be information indicating the congestion level of a specific store. Congestion may increase when a large number of customers exist in a store.

The processor 130 may control the display 140 to display congestion level information of a specific store in the form of a congestion level information icon 1404.

The congestion level information icon 1404 may be provided in the form of a plurality of human-shaped images. In this case, the processor 130 may display some human-shaped images among the plurality of human-shaped images to be in a specific color according to the congestion level of the specific store. For example, when people flock to a specific store and the congestion level increases, the number of human-shaped images displayed in the specific color may increase. However, the congestion level information does not need to be displayed in the above-described manner, and may be displayed in any manner as long as it can display the congestion level of a specific store.

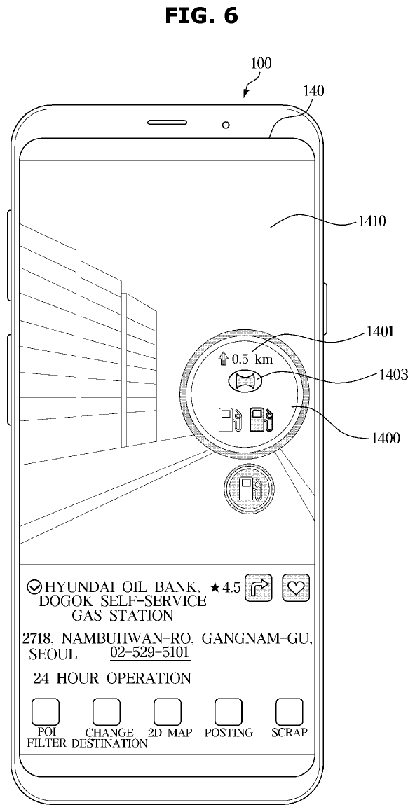

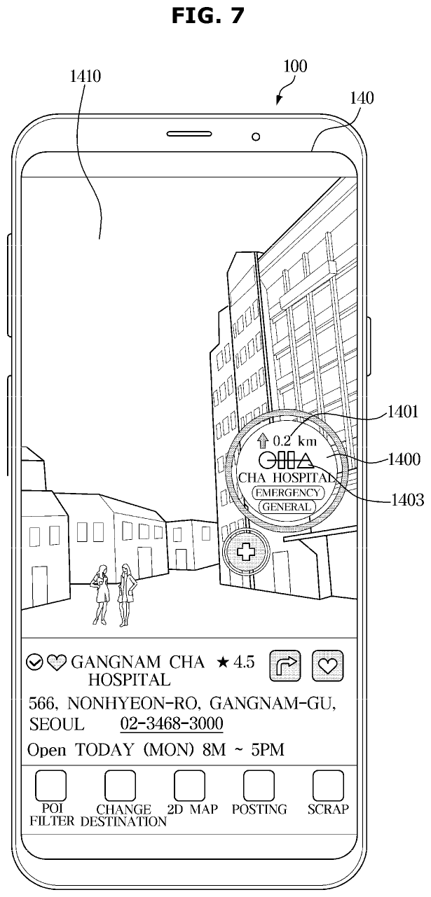

FIG. 6 is a diagram for describing a case in which a gas station is a POI according to an embodiment, and FIG. 7 is a diagram for describing a case in which a hospital is a POI according to an embodiment.

Referring to FIGS. 6 and 7, the processor 130 may control the communication module to receive information about a plurality of POIs 300 from the server 200.

For example, if the user desires to visit a gas station, the user may input, to the user terminal 100, a command instructing to provide information about a gas station. In this case, the user terminal 100 may receive information about a plurality of gas stations in the vicinity of the user terminal 100 from the server 200.

When the user desires to visit a hospital, the user terminal 100 may receive information about a plurality of hospitals in the vicinity of the user terminal 100 from the server 200.

The processor 130 may determine a recommended POI 300 based on at least one of user evaluation information POIs, price information of a service, and congestion level information for each of the plurality of POIs 300 received from the server 200.

The recommended POI 300 may be a POI 300 that is a target whose information is provided through the icon 1400 among the plurality of POIs 300.

For example, if the user desires to visit a gas station, the processor 130 may determine a gas station to be recommended, based on such information as user evaluation information, a gasoline price, a diesel price, the number of waiting people, and the like for each of the plurality of gas stations.

In addition, if the user desires to visit a hospital, the processor 130 may determine a hospital to be recommended, based on user evaluation information, the number of waiting people, and the like for each of the plurality of hospitals.

Meanwhile, the information about the plurality of POIs 300 serving as a reference for determining the recommended POI 300 may not be limited to the user evaluation information, the price information of service, and the congestion level information. For example, the processor 130 may determine the POI 300 to be recommended, based on the distance from the user terminal 100 to each of the plurality of POIs 300.

In addition, the information about the plurality of POIs 300 serving as a reference for determining the recommended POI 300 may vary depending on the type and characteristics of the POI 300.

The processor 130 may generate the icon 1400 in which location information of the recommended POI 300 is displayed. In this case, the processor 130 may generate a composite image by synthesizing the icon 1400 on which the location information of the recommended POI 300 is displayed in a partial area of the surrounding image, and display the composite image on the display 140 of the user terminal 100.

At least one component may be added or omitted to correspond to the performances of the components described above. In addition, the mutual positions of the components may be changed to correspond to the performance or structure of the system.

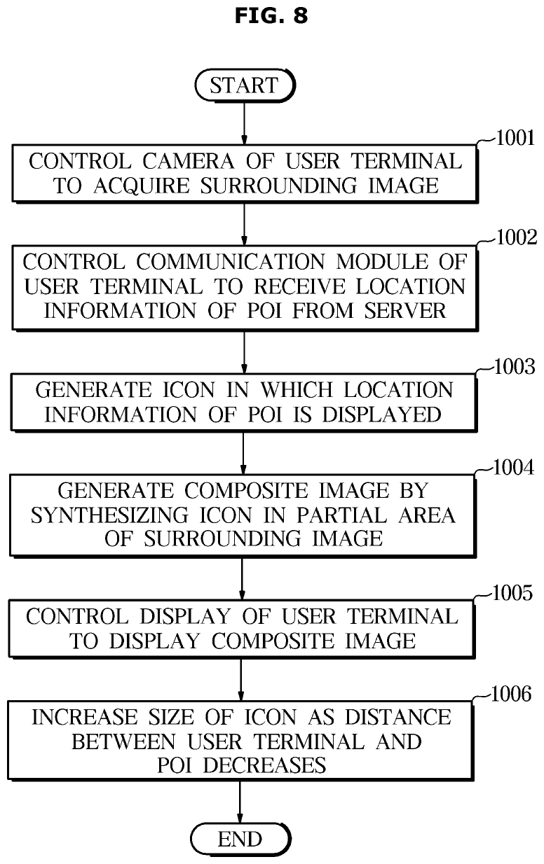

FIG. 8 is a flowchart showing an information displaying method according to an embodiment. This is merely exemplary and it should be understood that some of the components may be added or omitted if required,

Referring to FIG. 8, the processor 130 may control the camera 110 of the user terminal 100 to acquire a surrounding image (1001). In this case, the surrounding image acquired by the camera 110 under the control of the processor 130 may be transmitted to the processor 130.

The processor 130 may control the communication module 120 of the user terminal 100 to receive location information of the POI 300 from the server 200 (1002). In this case, the processor 130 may control the communication module 120 to receive not only the location information but also various pieces of information about the POI 300 from the server 200, such as information about whether the POI 300 is open, user evaluation information of the POI 300, price information of a service of the POI 300, and congestion level information of the POI 300.

The processor 130 may generate an icon 1400 in which the location information of the POI 300 is displayed (1003). In this case, the processor 130 may control the display 140 to display not only the location information of the POI 300, but also the various pieces of information about the POI 300, such as operation status information of the POI 300, user evaluation information of the POI 300, price information of a service of the POI 300, and congestion level information of the POI 300 on the icon 1400.

The processor 130 may generate a composite image by synthesizing the icon 1400 in a partial area of the surrounding image (1004).

The processor 130 may control the display 140 of the user terminal 100 to display the composite image (1005). Accordingly, the user may simultaneously check the image of the surrounding environment and the information about the POI 300 through the display 140.

The processor 130 may increase the size of the icon 1400 as the distance between the user terminal 100 and the POI 300 decreases (1006). Conversely, the processor 130 may decrease the size of the icon 1400 as the distance between the user terminal 100 and the POI 300 increases.

On the other hand, the processor 130 may control the display 140 to, based on the distance between the user terminal 100 and the POI 300 decreasing to a value less than a preset value, display a logo of the POI 300 on the icon 1400.

As is apparent from the above, according to one aspect of the disclosure, the information displaying method and the computer-readable recording medium in which a program for executing the information displaying method is stored can display, on a display, a composite image by synthesizing an icon, in which information about a point of interest (POI) is displayed, in a partial area of a surrounding image, and can change the size of the icon based on the distance between the user terminal and the POI.

Although embodiments of the present disclosure have been described for illustrative purposes, those skilled in the art will appreciate that various modifications, additions and substitutions are possible, without departing from the scope and spirit of the disclosure. Therefore, embodiments of the present disclosure have not been described for limiting purposes.

What is claimed is:

1. An image displaying method comprising:
acquiring an image of a surrounding area of a user terminal;
receiving location information of a point of interest (POI) from a server;
displaying a composite image by synthesizing an icon, in which the location information of the POI is displayed, in a partial area of the surrounding image; and
changing a size of the icon based on a distance between the user terminal and the POI.

2. The image displaying method of claim 1, wherein
the changing of the size of the icon includes
increasing the size of the icon as the distance between the user terminal and the POI decreases.

3. The image displaying method of claim 1, further comprising:
receiving information about whether the POI is open or closed from the server; and
displaying the information about whether the POI is open or closed on the icon.

4. The image displaying method of claim 3, wherein the displaying of the information about whether the POI is open or closed on the icon includes displaying on the icon different colors respectively indicating whether the POI is open or closed.

5. The image displaying method of claim 1, further comprising displaying a logo of the POI on the icon.

6. The image displaying method of claim 5, wherein the displaying of the logo of the POI on the icon includes,
in response to the distance between the user terminal and the POI being less than a preset value, displaying the logo of the POI on the icon.

7. The image displaying method of claim 1, wherein the POI includes a parking lot, and
wherein the image displaying method further comprises:
displaying at least one of user evaluation information for the parking lot, parking fee information for the parking lot, or parking available space information for the parking lot on the icon.

8. The image displaying method of claim 7, wherein the displaying of the parking available space information includes displaying different colors on the icon respectively indicating whether a ratio of a parking available space to a total parking space of the parking lot being greater than or equal to, or less than a reference ratio.

9. The image displaying method of claim 1, wherein the POI includes a store,
wherein the image displaying method further comprises displaying at least one of user evaluation information for the store, price information of a service for the store, or congestion level information for the store on the icon.

10. The image displaying method of claim 1, further comprising:
receiving information about a plurality of POIs from the server; and
determining a recommended POI based on at least one of user evaluation information, price information of a service, or congestion level information for each of the plurality of POIs;
wherein the displaying of the composite image comprises:
generating the icon to include location information of the recommended POI.

11. A non-transitory computer-readable recording medium storing a program for an information displaying method, the program executable by a processor to cause the processor to perform operations comprising:
acquiring an image of a surrounding area of a user terminal;
receiving location information of a point of interest (POI) from a server;
displaying a composite image by synthesizing an icon, in which the location information of the POI is displayed, in a partial area of the surrounding image; and
changing a size of the icon based on a distance between the user terminal and the POI.

12. The non-transitory computer-readable recording medium of claim 11, wherein
the changing of the size of the icon includes
increasing the size of the icon as the distance between the user terminal and the POI decreases.

13. The non-transitory computer-readable recording medium of claim 11, wherein the operations further comprise:
receiving information about whether the POI is open or closed from the server; and
displaying the information about whether the POI is open on the icon.

14. The non-transitory computer-readable recording medium of claim 13, wherein the displaying of the information about whether the POI is open or closed on the icon includes displaying on the icon different colors respectively indicating whether the POI is open or closed.

15. The non-transitory computer-readable recording medium of claim 11, wherein the operations further comprise displaying a logo of the POI on the icon.

16. The non-transitory computer-readable recording medium of claim 15, wherein the displaying of the logo of the POI on the icon includes,
in response to the distance between the user terminal and the POI being less than a preset value, displaying the logo of the POI on the icon.

17. The non-transitory computer-readable recording medium of claim 11, wherein the POI includes a parking lot, and
wherein the operations further comprise
displaying at least one of user evaluation information for the parking lot, parking fee information for the parking lot, or parking available space information for the parking lot on the icon.

18. The non-transitory computer-readable recording medium of claim 17, wherein
the displaying of the parking available space information includes displaying different colors on the icon respectively indicating whether a ratio of a parking available space to a total parking space of the parking lot being greater than or equal to, or less than a reference ratio.

19. The non-transitory computer-readable recording medium of claim 11, wherein the POI includes a store,
wherein the operations further comprise displaying at least one of user evaluation information for the store, price information of a service for the store, or congestion level information for the store on the icon.

20. The non-transitory computer-readable recording medium of claim 11, wherein the operations further comprise:
receiving information about a plurality of POIs from the server; and
determining a recommended POI based on at least one of user evaluation information, price information of a service, or congestion level information for each of the plurality of POIs;
wherein the displaying of the composite image comprises:
generating the icon to include location information of the recommended POI.
